(19) United States
(12) Patent Application Publication
(10) Pub. No.: US 2012/0009302 A1
(43) Pub. Date: Jan. 12, 2012

(54) HYBRID PIZZA-LASAGNA FOOD PRODUCT

(76) Inventors: Brian Farrell, Oak Lawn, IL (US); John McNulty, Chicago, IL (US); Lisa Vishoot, Lake in the Hills, IL (US)

(21) Appl. No.: 12/834,090

(22) Filed: Jul. 12, 2010

(51) Int. Cl. A21D 13/00; A23L 1/16; A23C 19/09; A23L 1/31

(52) U.S. Cl. 426/92; 426/94

(57) ABSTRACT

A hybrid food product combines the elements of pizza with those of lasagna. The hybrid food product may include a typical pizza crust, a ricotta cheese layer on the crust, typical pizza toppings and lasagna layers. The lasagna layers may be arranged in different directions to increase the structural strength of the food product.

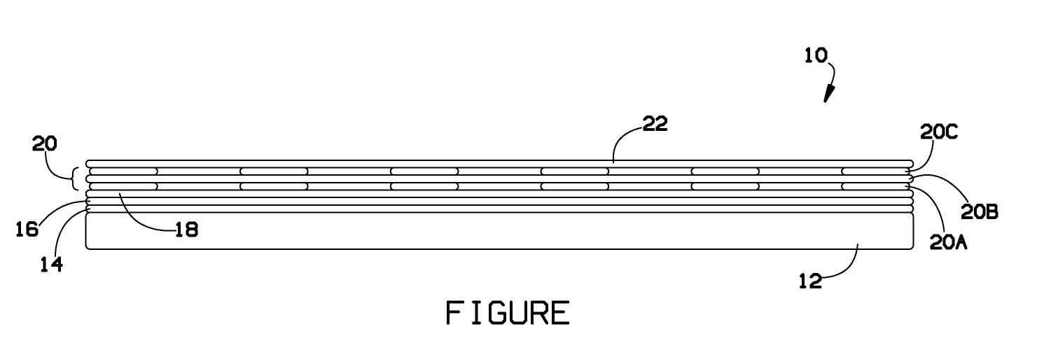

### BACKGROUND OF THE INVENTION

The present invention relates to a food product and, more particularly, to a hybrid food product that combines elements of both pizza and lasagna.

There are a large number of food products available to the consumer. Many of these products are separately available, but may not be enjoyed as a combination. For example, some foods may be separately considered as entrée items and may not be served together at a meal to allow a consumer to try both entrées together at once. Other foods may not be combined due to difficulties in formulating the combination to give a final edible combined food product.

As can be seen, there is a need for a hybrid food product that may combine the flavors of pizza and lasagna in a single food product.

### SUMMARY OF THE INVENTION

In one aspect of the present invention, a hybrid food product comprises a pizza crust base; a ricotta cheese layer on the pizza crust base; standard pizza toppings on the ricotta cheese layer; and lasagna layers on top of the pizza toppings.

In another aspect of the present invention, a hybrid food product comprises a pizza crust base; a ricotta cheese layer on the pizza crust base; pizza sauce on the ricotta cheese layer; pizza toppings optionally disposed on the pizza sauce; and lasagna noodle layers on top of the pizza toppings, wherein the lasagna noodle layers are arranged in different directions between adjacent lasagna noodle layers.

These and other features, aspects and advantages of the present invention will become better understood with reference to the following drawings, description and claims.

### BRIEF DESCRIPTION OF THE DRAWINGS

The FIGURE shows a cross sectional view of a hybrid food product according to an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a hybrid food product that combines the elements of pizza with those of lasagna. The hybrid food product may include a typical pizza crust, a ricotta cheese layer on the crust, typical pizza toppings and lasagna layers.

Referring to the FIGURE, a hybrid food product 10 may include a pizza crust 12 as a base for the food product 10. The pizza crust 12 may be any conventional pizza crust and may have varying thickness depending on the likes of the consumer. The pizza crust 12 may contain alternate features, as may be known in the art, such as cheese embedded in the crust. A ricotta cheese layer 14 may be placed on top of the pizza crust 12. The ricotta cheese layer 14 may help set the stage for the lasagna layers, as discussed below.

On top of the ricotta cheese layer 14 may be placed standard pizza toppings. For example, a sauce layer 16 may be placed on the ricotta cheese layer 14. The sauce layer 16 may be a conventional tomato-based pizza sauce. Alternatively, the sauce layer 16 may be a cream sauce or a white sauce.

Typical pizza toppings 18 may be placed on the sauce layer 16. The pizza toppings 18 may include any number of products, including, but not limited to sausage, pepperoni, beef, ham, spinach, mushrooms, onions, olives, peppers and the like. The pizza toppings 18 may be optional. If not included, the lasagna layers, as discussed below, may be placed directly on top of the pizza sauce layer 16.

Lasagna layers 20 may be placed on top of the pizza toppings 18. The lasagna layers 20 may include from about 3 to about 4 layers of lasagna noodles 20a, 20b, 20c with optional cheese (such as ricotta cheese or cottage cheese, for example) and sauce (such as tomato sauce) between each of the layers of lasagna noodles 20a, 20b, 20c. In one embodiment, as shown in the FIGURE, the layers of lasagna noodles 20a, 20b, 20c may be arranged in an alternating manner, wherein the noodles of the first layer 20a may be placed, for example, across the food product, the second layer 20b may be placed perpendicular the first layer 20a, and the third layer 20c may be placed perpendicular to the second layer 20b (such that the first layer 20a and the third layer 20c may run in substantially the same direction). Such an arrangement may increase the structural strength of the hybrid food product 10.

A top layer 22 of mozzarella cheese and sauce may be disposed on top of the lasagna layers 20.

The resulting food product 10 may then be baked at, for example about 350 degrees for about 15-20 minutes, or until the top layer 22 begins to brown.

The resulting hybrid food product 10 may be served to a consumer to enjoy the combined elements of pizza and lasagna in a single entrée.

It should be understood, of course, that the foregoing relates to exemplary embodiments of the invention and that modifications may be made without departing from the spirit and scope of the invention as set forth in the following claims.

We claim:

1. A hybrid food product comprising:
a pizza crust base;
a ricotta cheese layer on the pizza crust base;
standard pizza toppings on the ricotta cheese layer; and
lasagna layers on top of the pizza toppings.

2. The food product of claim 1, wherein the ricotta cheese layer covers the entire surface of the pizza crust base.

3. The food product of claim 1, wherein the standard pizza toppings includes pizza sauce on the ricotta cheese layer.

4. The food product of claim 3, wherein the standard pizza toppings include at least one of sausage, pepperoni, beef, ham, spinach, mushrooms, onions, olives, and peppers on top of the pizza sauce.

5. The food product of claim 1, wherein the lasagna layers include from 3 to 4 lasagna noodle layers.

6. The food product of claim 5, wherein the lasagna noodle layers are arranged in different directions between adjacent layers.

7. The food product of claim 6, wherein each lasagna noodle layer is arranged at about 90 degree angles relative to the adjacent layer.

8. The food product of claim 7, wherein the lasagna noodle layers include at least one of sauce and cheese disposed between each layer.

9. A hybrid food product comprising:
a pizza crust base;
a ricotta cheese layer on the pizza crust base;
pizza sauce on the ricotta cheese layer;
pizza toppings optionally disposed on the pizza sauce; and
lasagna noodle layers on top of the pizza toppings, wherein
the lasagna noodle layers are arranged in different directions between adjacent lasagna noodle layers.

10. The food product of claim 9, wherein the lasagna noodle layers include at least one of sauce and cheese disposed between each layer.
